(19) United States
(12) Patent Application Publication
(10) Pub. No.: US 2008/0247521 A1
(43) Pub. Date: Oct. 9, 2008

(54) METHOD AND APPARATUS FOR VOICEMAIL DELIVERY

(75) Inventors: Haifeng Bi, San Antonio, TX (US); Xiaolian Bi, San Antonio, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/697,550

(22) Filed: Apr. 6, 2007

(51) Int. Cl. H04M 11/00

(52) U.S. Cl. 379/88.18

(57) ABSTRACT

A system and method for voicemail delivery is disclosed. A system that incorporates teachings of the present disclosure may include, for example, a voicemail system having a controller element to initiate a communication session with a communication device of a called party to supply one or more recorded voicemail messages. Additional embodiments are disclosed.

### FIELD OF THE DISCLOSURE

The present disclosure relates generally to communication systems, and more specifically to a system and apparatus for voicemail delivery.

### BACKGROUND

A voicemail system allows a caller placing a call to leave a voice message when a called party does not answer the call. The called party can later access the voicemail system to retrieve and listen to the voicemail. The voicemail may be a voice or text message, or a combination thereof. Current voicemail systems generally deliver voice messages in two steps. In a first step, the voicemail system notifies the called party of new messages in a mailbox on the voicemail system. In a second step, the called party places a call to the voicemail system to retrieve the new message from the mailbox.

As one example method, a voicemail system can set a Message Waiting Indicator (MWI) on a phone line associated with the mailbox. The MWI may be a light indication on the phone, and/or a sound that is played on the phone line, when the phone is lifted off-hook. The MWI effectively notifies the called party of awaiting messages. As another example method, the voicemail system can send a text notification via a pager or an email to the called party.

Although these methods have proven useful, they do not address situations where a called party is traveling, too busy to respond to the MWI notice, is forgetful about retrieving voicemail messages, or simply did not notice the status of the MWI on their phone. Consequently, unread voicemail messages can be residing in the called party's account for hours or days.

A need therefore arises for a system and apparatus for voicemail delivery.

### BRIEF DESCRIPTION OF THE DRAWINGS

FIG. 1 depicts an exemplary embodiment of a communication system;

FIG. 2 depicts an exemplary block diagram of a communication device operating in the communication system;

FIG. 3 depicts an exemplary method operating in portions of the communication system;

FIG. 4 depicts an exemplary graphical user interface for configuring a voicemail system operating in the communication system;

FIGS. 5-7 depicts exemplary methods operating in the voicemail system; and

FIG. 8 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and apparatus for voicemail delivery.

In a first embodiment of the present disclosure, a computer-readable storage medium can have computer instructions for recording a delivery time for supplying voicemail messages recorded by the voicemail system, recording a voicemail message supplied by a calling party directed to a called party, and initiating at the delivery time an interactive communication session with a communication device of the called party to supply the voicemail message.

In a second embodiment of the present disclosure, a voicemail system can have a controller element to initiate a communication session to a communication device of a called party to supply one or more recorded voicemail messages.

In a third embodiment of the present disclosure, a presence system can have a controller element to supply a voicemail system presence information associated with a called party for the voicemail system to initiate a communication session with a communication device identified in the presence information to supply the called party one or more recorded voicemail messages.

In a fourth embodiment of the present disclosure, a method for supplying a voicemail message can involve initiating one or more communication sessions with one among one or more communication devices of a called party to supply a recorded voicemail message.

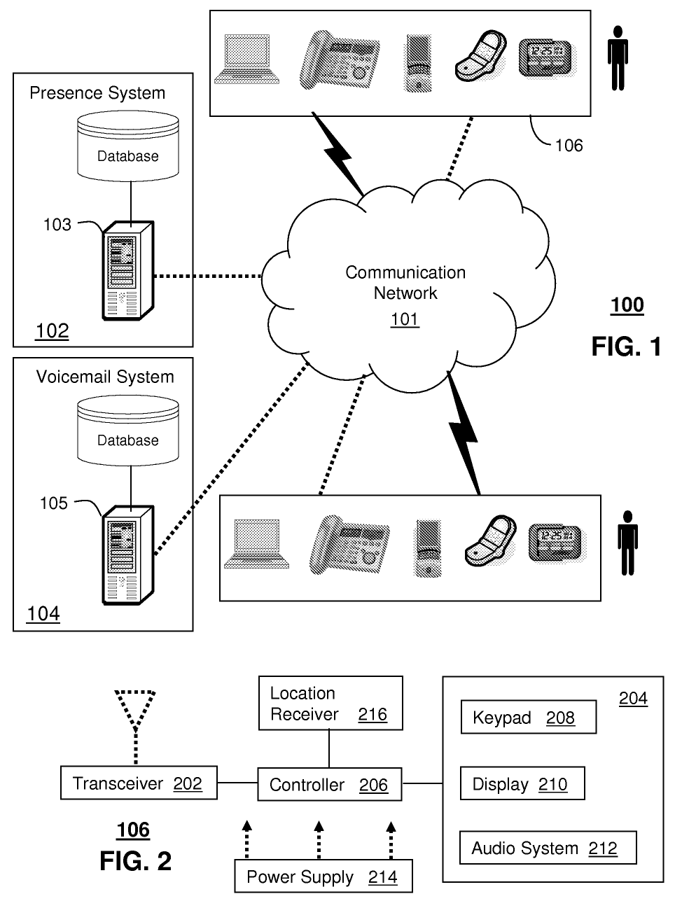

FIG. 1 depicts an exemplary embodiment of a communication system 100. The communication system 100 can comprise a presence system 102, a voicemail system 104, and one or more communication devices 106 coupled through a communication network 101. The foregoing components 102-106 of the communication system 100 can utilize common computing and communications technologies to support circuit-switched and/or packet-switched communications.

The presence system 102 can be utilized to track the whereabouts and status of a party communicating with one or more of the communication devices 106 in the communications network 101. In the arrangement shown, the presence system 102 can include a controller element 103 that supplies a voicemail system presence information of a requested party. Presence information can include a location of a party utilizing a communication device 106, the type of device used by the party (e.g., cell phone, PDA, home phone, home computer, etc.), and/or a status of the party (e.g., busy, offline, actively on a call, actively engaged in instant messaging, etc.). The presence system 102 performs said operations for parties who are subscribed to services of the presence system 102.

The voicemail system 104 can be utilized to record voicemail messages supplied by a called party. In the arrangement shown, the voicemail system 104 includes a controller element 105 corresponding to a processor, a programmable storage medium, a server, or any other suitable computing component. The voicemail message supplied by a calling party can include a caller ID retrieved from a call initiated by the calling party over the communication network 101 utilizing common signal processing means, and a voicemail message supplied thereby.

The voicemail system 104 can also include technology such as found in an interactive voice response system (IVR) for interacting with the calling and called parties utilizing voice and keyed input signals (e.g., DTMF tones), and for processing a voicemail message supplied by the calling party according to a particular call flow design. The presence and voicemail systems 102-104 can be provisioned to interact cooperatively to enhance processing of voicemail messages.

The communication network 101 comprises a number of common network elements interconnected by wired or wireless interfaces that support packet-switched and/or circuit-switched technologies. The communications network 101 can thus offer communication devices 106 Internet and/or traditional voice services such as, for example, POTS (Plain Old Telephone Service), Public Switched Telephone Network (PSTN), VoIP (Voice over Internet Protocol), IPTV (Internet Protocol Television), broadband communications, cellular telephony, as well as other known or next generation access technologies.

The communication devices 106 can represent any number of embodiments including without limitation a laptop or desktop computer, a POTS phone, a personal digital assistance (PDA), a cellular phone, or paging device, just to name a few. Some or all of these devices can interface to the communication network 101 with a wired or wireless interface. For example, the laptop can be interconnected to the communications network 101 by a wired Ethernet port to a DSL (Digital Service Line) interface in a residence or enterprise, or by an IEEE 802.x Wireless Local Area Network (WLAN), Wireless Fidelity (WiFi) or Worldwide Interoperability for Microwave Access (WiMAX) wireless connection. The POTS phone can utilize cordless 2.4 GHz or 5.8 GHz technology for short-range roaming, and interface to the communications network 101 using POTS or VoIP communications. The PDA and cellular phone can support common wireless access technologies such as cellular and WiFi for interfacing to the communications network 101.

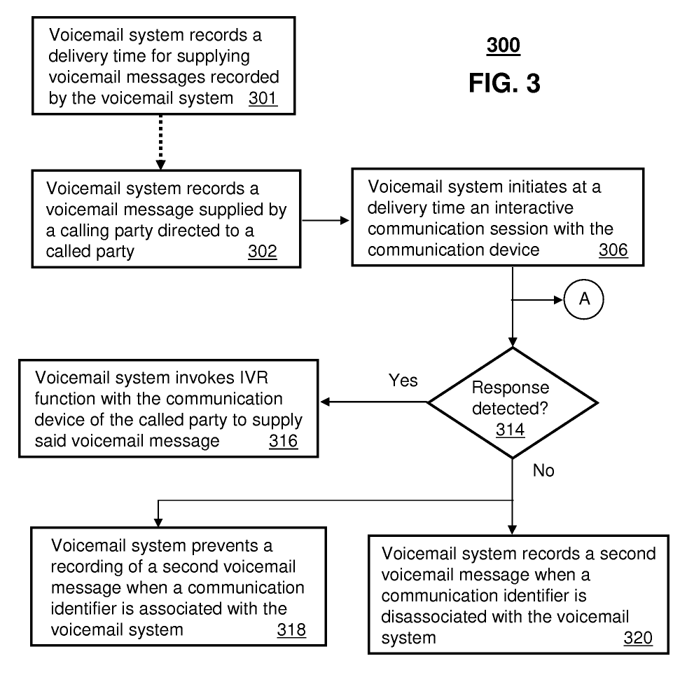

FIG. 2 depicts an exemplary embodiment of the communication device 106. The communication device 106 can comprise a wired and/or wireless transceiver 202, a user interface (UI) 204, a power supply 214, a location receiver 216, and a controller 206 for managing operations thereof. In an embodiment where the communication device 106 operates in a landline environment, the transceiver 202 can utilize common wire-line access technology to support POTS or VoIP services.

In a wireless communications setting, the transceiver 202 can utilize common technologies to support singly or in combination any number of wireless access technologies including without limitation cordless phone technology (e.g., DECT), Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing a public or private communication spectrum according to any number of communication protocols that can be dynamically downloaded over-the-air to the communication device. It should be noted also that next generation wireless access technologies can be applied to the present disclosure.

The UI 204 can include a keypad 208 with depressible or touch sensitive navigation disk and keys for manipulating operations of the communication device 106. The UI 204 can further include a display 210 such as monochrome or color LCD (Liquid Crystal Display) for conveying images to the end user of the communication device, and an audio system 212 that utilizes common audio technology for conveying and intercepting audible signals of the end user.

The power supply 214 can utilize common power management technologies such as replaceable batteries, supply regulation technologies, and charging system technologies for supplying energy to the components of the communication device and to facilitate portable applications. In stationary applications, the power supply 214 can be modified so as to extract energy from a common wall outlet and thereby supply DC power to the components of the communication device 106.

The location receiver 216 can utilize common technology such as a GPS (Global Positioning System) receiver that can intercept satellite signals and therefrom determine a location fix of the communication device 106.

The controller 206 can utilize computing technologies such as a microprocessor and/or digital signal processor (DSP) with associated storage memory such a Flash, ROM, RAM, SRAM, DRAM or other like technologies for controlling operations of the aforementioned components of the communication device.

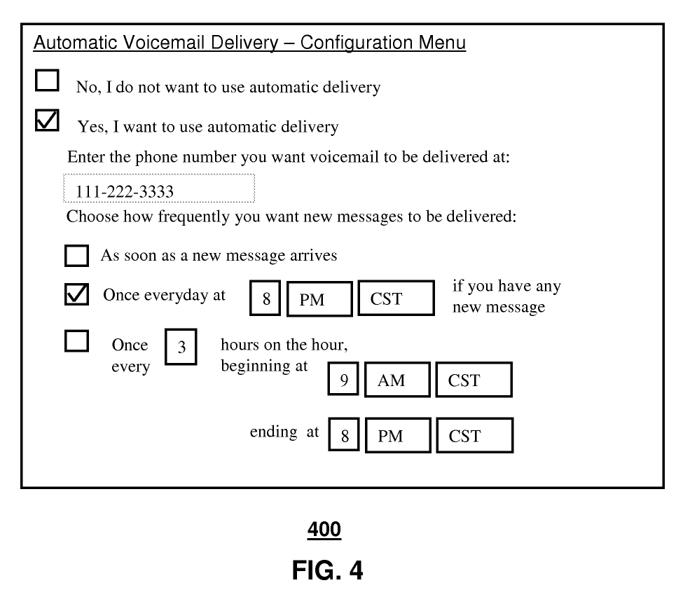

FIG. 3 depicts an exemplary method 300 operating in portions of the communication system 100. Method 300 begins with step 301 in which the voicemail system 104 records a delivery time for supplying voicemail messages recorded by the voicemail system. The delivery time identifies when the voicemail messages are to be delivered, and can be pre-specified by the called party (i.e., subscriber of the voicemail system 104). The called party can also specify phone numbers, communication devices, or locations to provide alerts for any new messages at a scheduled time.

A subscriber can, for example, direct the voicemail system 104 to record a plurality of delivery times for supplying voicemail messages. Each delivery time can be associated with a dissimilar calendar period. For instance, the subscriber can direct the voicemail system 104 to deliver voicemail messages beginning at 6 pm for messages received between 8 am and 5:59 pm. Voicemail messages received after 6 pm are to be delivered at 7 am the next day.

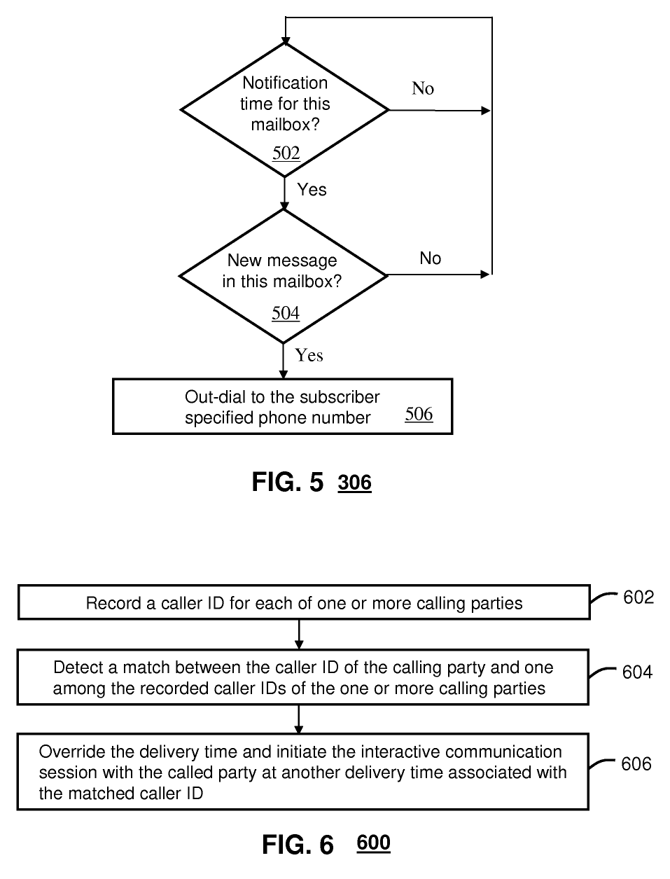

Briefly referring to FIG. 4, a graphical user interface (GUI) is shown representing a configuration menu 400 for provisioning the voicemail system 104 for automatic voicemail delivery. The configuration menu 400 can be accessed remotely through a website, directly from a user interface 204 on the communication device 106, or through human on-line or phone assistance, though other means are herein contemplated. In one arrangement, the subscriber can access a web portal that is associated with the voicemail system 104. The configuration menu 400 can also be accessed with the IVR of the voicemail system 104. A subscriber can configure his or her preferences concerning voicemail delivery through any of the aforementioned techniques. Thus with the configuration menu 400 the subscriber can specify automatic delivery, phone numbers at which voicemail messages are to be delivered, and a schedule for such deliveries. The configuration menu 400 can also include additional fields for cases in which multiple phone numbers are given in association with different delivery times.

Additionally, a configuration menu 400 can be provided for each voicemail box of a corresponding phone number. The configuration information, once specified, can then be stored in the voicemail system 104 and associated with an identified mailbox. In such regard, a subscriber can customize scheduling and delivery to different communication devices 106 having different phone numbers. The subscriber can continually make modifications to the configuration menu as needed. Notably, the configuration menu 400 allows a subscriber to self-adjust schedule times as to when the voicemail system 104 should call the subscriber to delivery voicemail messages.

Step 301 of FIG. 3 therefore corresponds to a configuration step that can be initiated by the subscriber at will. Once the voicemail system 104 has been configured, it proceeds to step 302 in which it records a voicemail message supplied by a calling party directed to a called party when said called party does not answer the call placed by the calling party. In step 306, the voicemail system 104 attempts to initiate an interactive communication session with the communication device 106 specified in step 301 at the delivery time by way of the configuration menu 400.

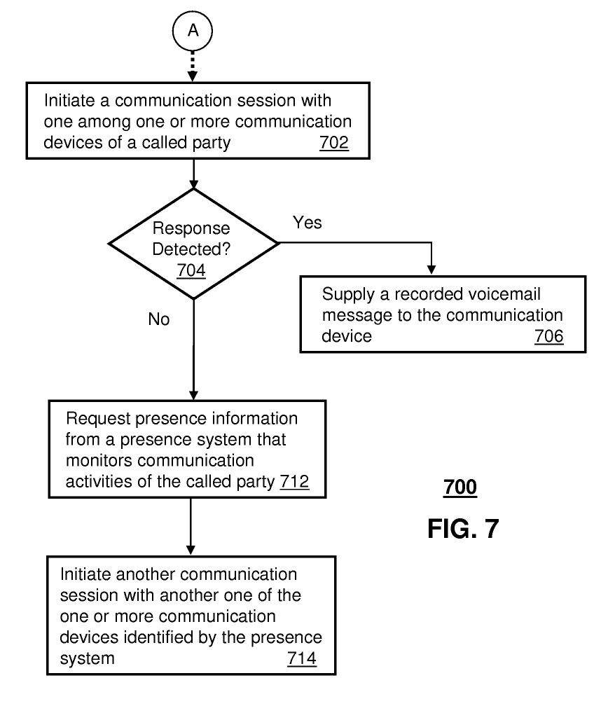

FIG. 5 depicts an embodiment of a flowchart for implementing step 306. At step 502, the voicemail system 104 can determine a delivery time for a particular mailbox (or voicemail account) in the voicemail system. The delivery time identifies when the subscriber is to be supplied new voicemail messages as described above for the configuration menu 400. In step 504, at the delivery time, the voicemail system 104 can determine if there any new messages in the mailbox. If there are no new messages, the voicemail system 104 can continue to monitor for new messages and deliver them at subsequent delivery times. If new voicemail messages are in the mailbox, the voicemail system 104 in step 506 proactively dials the number supplied by the subscriber to deliver the voicemail messages.

Referring back to FIG. 3, in step 314, the voicemail system 104 determines whether the called party (e.g. subscriber) is available to receive one or more voicemail messages. If the called party answers the call initiated in step 506, the voicemail system 104 can proceed to deliver the new voicemail messages. Accordingly, in step 316, the voicemail system 104 utilizes the IVR function to initiate an interactive communication session with the called party by way of the communication device 106 to supply one or more voicemail messages. The voicemail system 104 can also apply a charge or fee to the subscriber for making the delivery call. The voicemail system 104 can also implement charging policies based on local, long distance, or toll free numbers, which can be made available to the subscriber in the configuration menu 400.

During the interactive communication session, voice interactions between the voicemail system 104 and the called party, and Dual Tone Multi Frequency (DTMF) signals supplied by the called party by way of the communication device 106 can be processed by the IVR. The IVR can present the subscriber with audio or visual navigation menus to retrieve the voicemail. As one example, the IVR can greet the subscriber by announcing that the call is associated with a delivery of voicemail messages. The greeting can also indicate the mailbox phone number associated with the delivery.

As another example, the IVR can present a voice menu list requiring the subscriber to enter a password to retrieve the voicemail. This feature can serve as a precaution in the event that the subscriber has listed a communication device 106 in the configuration menu 400 that is not owned by the subscriber, such as a friend's mobile device, a computer, or public telephone. The IVR can authenticate and/or authorize the retrieval of voicemail messages through the IVR user interface.

Suppose a subscriber has a mailbox associated with 210-555-5555. The subscriber has activated automatic delivery for that mailbox to 210-666-6666—a number different from the phone number of the mailbox (210-555-5555). At the specified delivery time the voicemail system 104 will out dial to 210-666-6666. When the subscriber answers the call, he/she will hear an announcement from the IVR, for example:

“Hello, this is your automatic voicemail delivery call, for mailbox 210 555 5555”

Then the standard mailbox IVR menu follows, for example:

“Please enter your PIN.”

Once the PIN is correctly entered, the IVR plays, for example:

“To listen to your new voice message, press 1”.

Returning back to FIG. 3, at step 314, the voicemail system 104 can perform certain operations if it does not receive a response to the voicemail delivery call. A special condition is considered to ensure that the delivery call itself does not turn into new voice messages which could create a feedback loop of voicemail messages. This situation can be divided into the following two cases:
The specified notification number (i.e. the out-dialed number) is the same as the mailbox phone number, or
The specified notification number (i.e. the out-dialed number) is different than the mailbox phone number.

In the first case, if the specified notification number is the same as the mailbox phone number, and if the subscriber does not answer a delivery call, then the telephone network will route the delivery call to the same voicemail system 104, in an attempt to leave the subscriber a message. The voicemail system 104 then terminates the call by detecting the calling phone number being its own, and not causing any new messages to be left in the subscriber's mailbox. This effectively avoids the aforementioned message loop. This corresponds to step 318 of FIG. 3, wherein the voicemail system 104 prevents a recording of a second voicemail message when the communication identifier is associated with the voicemail system 104.

In the second case, if the specified delivery number is different than the mailbox phone number, and if the subscriber does not answer, then the telephone network 101 will route the notification call to a foreign voicemail system disassociated with the voicemail system 104 that performed the out-dial in step 506 of FIG. 5. In this case, when the foreign voicemail system answers the call, the voicemail system 104 is presented a common IVR notification for supply a voicemail message. The voicemail system 104 can be programmed to detect a voicemail request signal (such as a common “beep” to leave a message) and begin to deliver a new voicemail message that informs the called party that the voicemail system 104 has made an attempt to deliver voicemail messages to this number without actually delivering the voicemail messages. This corresponds to step 318 of FIG. 3, wherein the voicemail system 104 records a second voicemail message when the communication identifier is disassociated with the voicemail system 104.

Referring to FIG. 6, another method is provided in which the delivery call placed by the voicemail system 104 occurs at a time different from the delivery time specified in step 301 responsive to a caller ID of a select called party. Method 600 begins with step 602 in which the voicemail system 104 records a caller ID for each of one or more calling parties specified by the subscriber. This step can be inclusive in step 301 in which separate fields are provided in the configuration menu 400 so that the subscriber can identify exceptions to the delivery time. Once the voicemail system 104 has been configured with these exceptions, at step 604, it can be programmed to detect a match between the caller ID of the calling party and one among the recorded caller IDs supplied by the subscriber. When a match is detected, at step 606, the voicemail system 104 can override the delivery time and initiate the interactive communication session with the called party at another delivery time. The other delivery time can be specified by the subscriber as an immediate delivery or a delivery later than originally specified in step 301.

Referring to FIG. 7, another method for voicemail delivery is shown. At step 702, the voicemail system 104 can initiate a communication session with one among one or more communication devices 106 of a called party responsive to a delivery time being triggered in step 306 of FIG. 3 as previously described. At step 704, the voicemail system 104 can determine if the called party responds to the delivery call. If the called party responds the voicemail system 104 can proceed to deliver the voicemail messages in step 706. If the called party does not respond to the delivery call, the voicemail system 104 can request presence information from the presence system 102 that monitors communication activities of the called party as previously described.

The presence system 102 can for example utilize common means to detect that the called party is presently at home and has turned off his/her cell phone. Accordingly, a home number is a better choice for delivering voicemail messages to the subscriber. Alternatively, the presence server 102 can detect that the called party is roaming with his/her cell phone. Accordingly, in step 714, the voicemail system 104 can initiate another communication session with another one of the one or more communication devices 106 identified by the presence system 102 in view of the presence information.

The above methods provide a means for a voicemail system 104 to deliver voicemail messages proactively to a called party without the called party having to take the initiative to call the voicemail system 104. These methods can be useful to busy individuals who, for example, may be traveling, are forgetful about retrieving voicemail messages, or have inadvertently ignored a message waiting indicator of a communication device.

Upon reviewing the aforementioned embodiments, it would be evident to an artisan with ordinary skill in the art that said embodiments can be modified, reduced, or enhanced without departing from the scope and spirit of the claims described below. For instance, a subscriber of the voicemail system 104 can configure said system to deliver voicemails on weekdays differently than on weekends. In yet another embodiment, the voicemail system 104 can be programmed to check for presence information prior to a first attempt at communicating with the called party. To improve cost and response time, the presence system 102 and the voicemail system 104 can be integrated. In addition, methods 300, and 500-700 can be reduced, combined, or reordered without affecting the overall operations disclosed. These are but a few examples of how the present disclosure can be modified without deviating from the scope of the claims. Accordingly, the reader is directed to the claims section for a fuller understanding of the breadth and scope of the present disclosure.

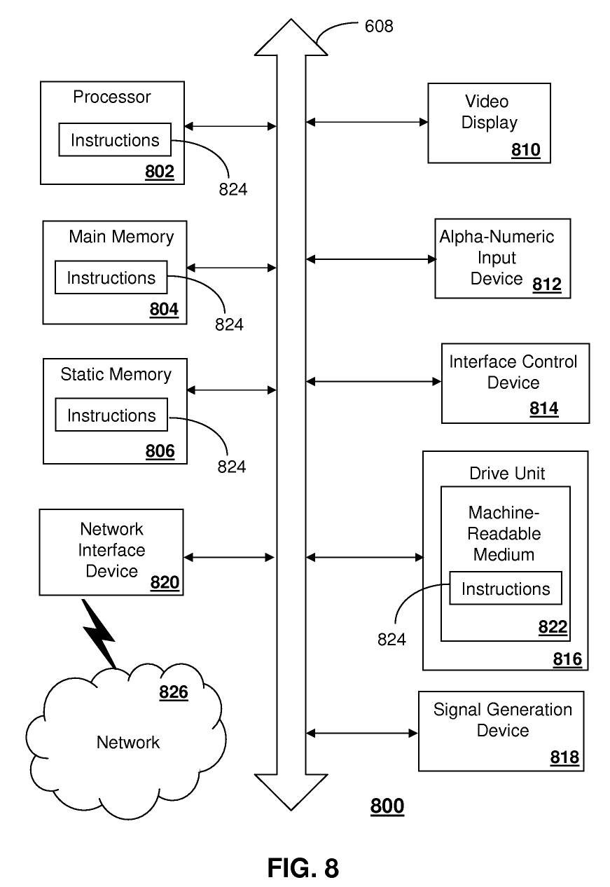

FIG. 8 depicts an exemplary diagrammatic representation of a machine in the form of a computer system 800 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU, or both), a main memory 804 and a static memory 806, which communicate with each other via a bus 808. The computer system 800 may further include a video display unit 810 (e.g., a liquid crystal display (LCD), a flat panel, a solid state display, or a cathode ray tube (CRT)). The computer system 800 may include an input device 812 (e.g., a keyboard), a cursor control device 814 (e.g., a mouse), a mass storage medium 816, a signal generation device 818 (e.g., a speaker or remote control) and a network interface device 820.

The mass storage medium 816 may include a computer-readable storage medium 822 on which is stored one or more sets of instructions (e.g., software 824) embodying any one or more of the methodologies or functions described herein, including those methods illustrated above. The computer-readable storage medium 822 can be an electromechanical medium such as a common disk drive, or a mass storage medium with no moving parts such as Flash or like non-volatile memories. The instructions 824 may also reside, completely or at least partially, within the main memory 804, the static memory 806, and/or within the processor 802 during execution thereof by the computer system 800. The main memory 804 and the processor 802 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the computer-readable storage medium 822 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a voicemail system, comprising computer instructions for:
recording a delivery time for supplying voicemail messages recorded by the voicemail system;
recording a voicemail message supplied by a calling party directed to a called party; and
initiating at the delivery time an interactive communication session with a communication device of the called party to supply said voicemail message.

2. The storage medium of claim 1, comprising computer instructions for:
recording a communication identifier associated with the communication device of the called party; and
initiating at the delivery time the interactive communication session with the communication device according to the communication identifier.

3. The storage medium of claim 2, comprising computer instructions for:
detecting no response from the communication device to retrieve the recorded voicemail message; and
preventing a recording of a second voicemail message when the communication identifier is associated with the voicemail system.

4. The storage medium of claim 2, comprising computer instructions for:
detecting no response from the communication device to retrieve the recorded voicemail message; and
recording a second voicemail message when the communication identifier is disassociated with the voicemail system.

5. The storage medium of claim 1, comprising computer instructions for:
detecting no response from the communication device to retrieve the recorded voicemail message;
requesting presence information from a presence server that monitors communication activities of the called party responsive to the detection step; and
initiating another interactive communication session with an alternate communication device according to an alternate communication identifier supplied by the presence server.

6. The storage medium of claim 1, comprising computer instructions for:
recording a caller ID for each of one or more calling parties;
detecting a match between the caller ID of the calling party and one among the recorded caller IDs of the one or more calling parties; and
overriding the delivery time and initiating the interactive communication session with the called party at another delivery time associated with the matched caller ID.

7. The storage medium of claim 6, comprising computer instructions for recording an alternate delivery time for each caller ID of the one or more calling parties.

8. The storage medium of claim 1, comprising computer instructions for:
recording a plurality of delivery times for supplying voicemail messages recorded by the voicemail system, each delivery time associated with a dissimilar calendar period;
selecting one of the plurality of delivery times according to a time when the voicemail message is recorded; and
initiating at the selected delivery time the interactive communication session with the called party.

9. The storage medium of claim 8, comprising computer instructions for:
recording for each of the plurality of delivery times a corresponding plurality of communication identifiers associated with a corresponding plurality of communication devices of the called party; and
initiating at the selected delivery time according to a corresponding communication identifier the interactive communication session with the communication device.

10. The storage medium of claim 1, wherein the interactive communication session comprises at least one among voice interactions between the voicemail system and the called party, and Dual Tone Multi Frequency (DTMF) signals supplied by the called party by way of the communication device.

11. The storage medium of claim 1, wherein the interactive communication session comprises one among packet-switched and circuit-switched communications taking place between the voicemail system and the communication device of the called party.

12. A voicemail system, comprising a controller element to initiate a communication session to a communication device of a called party to supply one or more recorded voicemail messages.

13. The voicemail system of claim 12, wherein the communication sessions are interactive with the called party comprising at least one among voice interactions, and Dual Tone Multi Frequency (DTMF) signals supplied by the called party by way of the communication device.

14. The voicemail system of claim 12, wherein the controller element:
records a delivery time and corresponding communication identifier for supplying voicemail messages recorded by the voicemail system; and
initiates at the delivery time the communication session with the communication device according to the corresponding communication identifier.

15. The voicemail system of claim 12, wherein the controller element:
detects no response from the communication device to retrieve the one or more recorded voicemail messages;
requests presence information from a presence server that monitors communication activities of the called party responsive to the detection step; and
initiates another communication session with an alternate communication device according to an alternate communication identifier supplied by the presence server.

16. The voicemail system of claim 14, wherein the controller element:
records a caller ID and corresponding alternate delivery time for each of one or more calling parties;
detects a match between the caller ID of a calling party that recorded one of the one or more voicemail messages and one among the recorded caller IDs of the one or more calling parties; and
overrides the delivery time and initiating the communication session with the called party at another delivery time associated with the matched caller ID.

17. The voicemail system of claim 12, wherein the controller element:
records a plurality of delivery times and corresponding plurality of communication identifiers for supplying voicemail messages recorded by the voicemail system, each delivery time associated with a dissimilar calendar period;
selects one of the plurality of delivery times according to a time when one or more of the voicemail message is recorded; and
initiates at the selected delivery time and communication identifier the communication session with the communication device of the called party.

18. A presence system, comprising a controller element to supply a voicemail system presence information associated with a called party for the voicemail system to initiate a communication session with a communication device identified in the presence information to supply the called party one or more recorded voicemail messages.

19. The presence system of claim 18, wherein the voicemail system submits a request for the presence information after a first attempt to communicate with the called party at another communication device.

20. A method for supplying a voicemail message, comprising initiating one or more communication sessions to one among one or more communication devices of a called party to supply a recorded voicemail message.

21. The method of claim 20, wherein the voicemail message corresponds to a recorded message supplied by a calling party to a voicemail system, wherein a call initiated by the calling party is redirected to the voicemail system in response to the called party not responding to the call.

22. The method of claim 20, comprising charging the called party a fee for each instantiation of the one or more communication sessions.

23. The method of claim 20, comprising initiating the one or more communication sessions at a designated delivery time.

24. The method of claim 20, comprising:
detecting no response from one among the one or more communication devices to retrieve the recorded voicemail message;
requesting presence information from a presence system that monitors communication activities of the called party; and
initiating another communication session with another one of the one or more communication devices identified by the presence system.
